(19) United States
(12) Patent Application Publication
(10) Pub. No.: US 2012/0211035 A1
(43) Pub. Date: Aug. 23, 2012

(54) CIRCULATOR ASSEMBLY FOR A PARTS WASHER

(75) Inventors: Rudy Publ, Glendale Heights, IL (US); Brad Thompson, Pingree Grove, IL (US)

(73) Assignee: Safety-Kleen Systems, Inc., Plano, TX (US)

(21) Appl. No.: 13/033,286

(22) Filed: Feb. 23, 2011

(51) Int. Cl. B08B 3/00; F16K 31/18

(52) U.S. Cl. 134/56 R; 137/409

(57) ABSTRACT

A parts washer may include a reservoir including a bottom, a cleaning solution having a surface, a cleaning chamber associated with the reservoir, a dispenser assembly in the cleaning chamber, a control assembly connected to one of the reservoir and the cleaning chamber, and a circulator assembly in the reservoir. The circulator assembly may include a pump, a float connected to the pump, a bracket including a guide and an actuator, a track that constrains movement of the pump and includes a switch to define a minimum pump orientation and to deactivate the circulator assembly.

### FIELD OF THE DISCLOSURE

The present disclosure is related to a parts washer assembly, and more particularly, to a parts washer assembly including, among other things, a circulator assembly including a float.

### BACKGROUND

Current parts washers generally include a reservoir (e.g., a 16, 30 or 55 gallon drum or vat), a cleaning chamber or receptacle (e.g., sink surmounted on the drum),

In numerous industries, such as in performing mechanical services in automobile parts repair and replacement and the like, there exists the crucial need to clean component mechanical parts prior to inspection, repair, or replacement thereof. Generally, such parts have been exposed to various contaminants such as dirt, grease and the like, which must be removed for effective repair or service. In the prior art, a variety of washing techniques have been employed to provide the requisite cleaning of the components as needed.

One highly effective parts washer, universally used in the industry, is described in U.S. Pat. No. 3,522,814 to Olson entitled Washer For Parts and the Like, to which reference herein is specifically made and incorporated herein by reference. The device described in Olson has been extremely successful in the industry by providing a parts washer having economical and hazard-free operation to subject parts to be cleaned to a circulating flow of solvent and the like. In operation of the device described in Olson, a pump fixed at the end of a rigid pipe circulates a cleaning solution from a reservoir (e.g., 16, 30 or 55 gallon drum or vat) into a cleaning chamber or receptacle containing parts for cleaning (e.g., sink surmounted on the drum). A flow of cleaning solution is directed against the parts and drains from the sink through a filter for return to the drum. In the event of a fire, the parts washer is capable of automatically closing a cover over the sink to minimize its effect. An improved version of the Olson parts washer includes a pump fixed at the end of a rigid pipe that is pivotally connected to the sink.

Although the Olson parts washer generally provides highly improved operative characteristics during cleaning, a disadvantage has been found that as the contaminants build up in the reservoir, the pump can actually draw in such contaminants rather than the lesser contaminated cleaning solution disposed above the bottom portion of the reservoir. Unfortunately, the improved version does not overcome the identified disadvantage.

Various different floating pumps have been disclosed that either float on the surface and draw in a liquid from the surface or have separate floats for the pump and inlets with the pump and inlets disposed near the surface. A disadvantage has been found with these configurations that they draw in the fluid from the surface, but that there are also contaminates that float on the surface that are introduced into the pump system. None of the floating pumps have been used in the environment of a parts washer.

Thus, it is highly advantageous that a parts washer be provided with a circulator assembly that draws the most clean fluid whenever possible during operation and that is adjustable with respect to various different reservoirs and otherwise overcomes the disadvantages of the prior art and provides the advantages as described in this disclosure.

### BRIEF DESCRIPTION OF THE DRAWINGS

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

FIG. 1 is an exploded perspective view of a parts washer assembly in accordance with one embodiment of the present disclosure.

FIG. 2 is a partial detailed view of a circulator assembly of FIG. 1.

FIG. 2A is a partial cross-sectional view of the circulator assembly of FIG. 2.

FIG. 3 is a top perspective partially cut-away view of one embodiment of the parts washer assembly of FIG. 1.

FIG. 4 is top perspective partially cut-away view of one embodiment of the parts washer assembly of FIG. 1.

### DETAILED DESCRIPTION

The present invention is not limited to the particular details of the assemblies depicted, and other modifications and applications may be contemplated. Further changes may be made in the assemblies without departing from the true spirit of the scope of the disclosure herein involved. It is intended, therefore, that the subject matter in this disclosure should be interpreted as illustrative, not in a limiting sense.

In one aspect of the present disclosure, a parts washer may include a reservoir including a bottom, a cleaning solution having a surface, a cleaning chamber associated with the reservoir, a dispenser assembly in the cleaning chamber, a control assembly connected to one of the reservoir and the cleaning chamber, and a circulator assembly in the reservoir. The circulator assembly may include a pump, a float connected to the pump, a bracket including a guide and an actuator, a track that constrains movement of the pump and includes a switch to define a minimum pump orientation and to deactivate the circulator assembly.

In another aspect of the present disclosure, a parts washer may include a reservoir having a bottom, a cleaning solution disposed within the reservoir including a surface, a cleaning chamber operatively associated with the reservoir, a dispenser assembly disposed in the cleaning chamber for dispensing the cleaning solution in the cleaning chamber, a control assembly operatively connected to one of the reservoir and the cleaning chamber, and a circulator assembly disposed in the reservoir and operatively connected to the dispenser assembly. The circulator assembly may include a pump, a float connected to the pump to generate a neutral buoyancy such that the pump is disposed above the bottom and below the surface, a bracket connected to one of the pump and the float, the bracket including a guide and an actuator, a track slidably engaging the guide so as to constrain movement of the pump, the track including a switch adjustably disposed in the track to define a minimum pump orientation, wherein, when actuated by interaction with the actuator, the switch deactivates the circulator assembly.

In a further aspect of the present disclosure an embodiment of the above parts washer may include the bracket having an arm to space the pump from a wall of the reservoir, the arm having two extensions, the guide configured as a cylindrical passage, the track having a bore, the switch disposed within the bore, the switch is disposed at a desired orientation that is relative to a configuration of the reservoir, or the track having a distal end disposed adjacent the bottom and a proximate end disposed above the surface.

In yet another aspect of the present disclosure, a circulator assembly for use in connection with a parts washer assembly may include a reservoir and a cleaning solution having a surface disposed in the reservoir. The circulator assembly may include a pump, a float connected to the pump to generate a neutral buoyancy such that the pump is disposed above the bottom and below the surface, a bracket connected to one of the pump and the float that may include a guide and an actuator, a track slidably engaging the guide to constrain movement of the pump and including a switch adjustably disposed in the track to define a minimum pump position, wherein, when actuated by interaction with the actuator, the switch deactivates the circulator assembly.

In a still further aspect of the present disclosure, the circulator assembly may include the bracket having an arm to space the pump from a wall of the reservoir, the arm having two extensions, the guide configured as a cylindrical passage, the track having a bore, the switch disposed within the bore, or the track having a distal end disposed adjacent the bottom and a proximate end disposed above the surface.

In still yet another aspect of the present disclosure, a circulator assembly for a body of cleaning solution having a surface may include a floating pump disposed below the surface that slidably engages a track to constrain movement of the pump and the track may include a switch that, when actuated by interaction of the adjacent pump, deactivates the circulator assembly.

In another aspect of the present disclosure, the circulator assembly may include a bracket connected to the pump having a guide to engage the track and an actuator that interacts with the switch, the bracket having an arm to space the pump from a wall of the reservoir, the track having a bore, or the switch disposed within the bore.

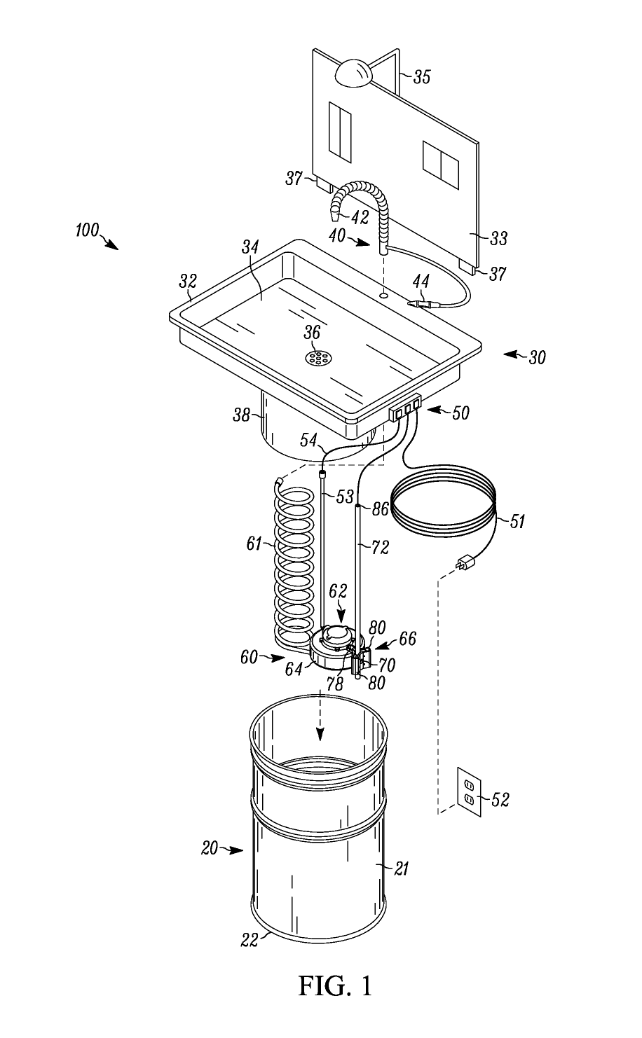

FIG. 1 is an exploded perspective view of a parts washer assembly 100 in accordance with one embodiment of the present disclosure. The parts washer assembly 100 may include a reservoir 20 having a bottom 22. It is within the teaching of the present disclosure that the reservoir 20 may have any suitable configuration, such as, for example, a drum having a 16, 30 or 55 gallon capacity or larger, a generally rectangular cube configuration, such as a vat, or any other suitable configuration.

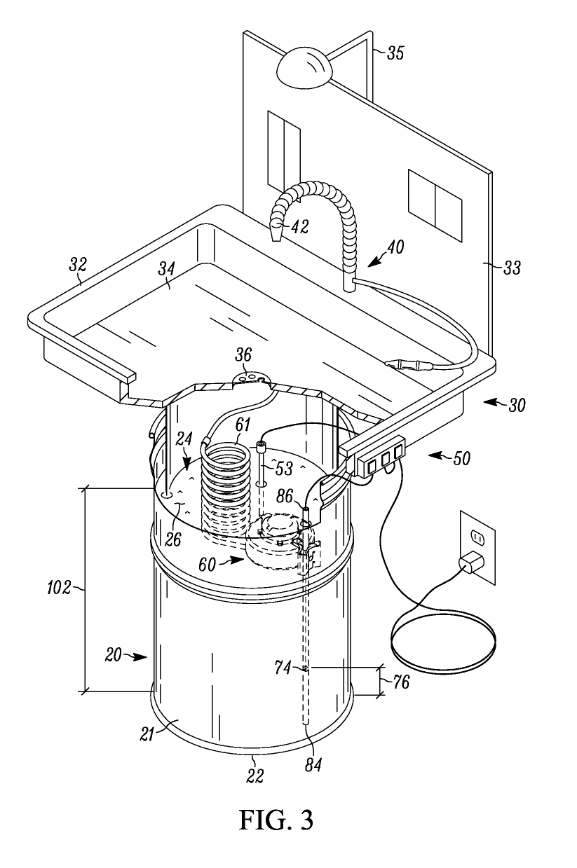

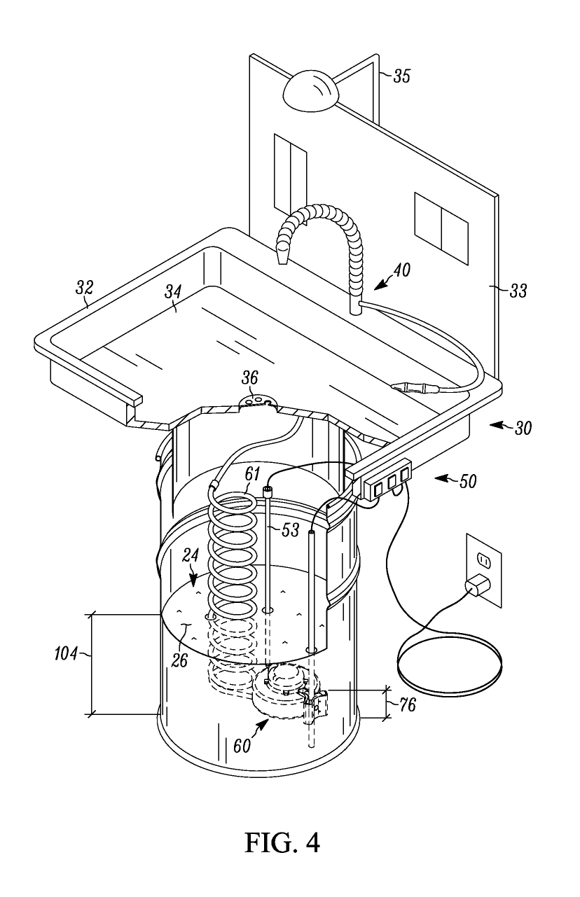

A cleaning solution 24 (see FIGS. 3 and 4) may be disposed within the reservoir 20 so as to define a surface 26 (see FIGS. 3 and 4) of the cleaning solution 24. It is within the teachings of the present disclosure that the cleaning solution 24 may be any suitable fluid useful to provide the intended functionality, such as, for example, a solvent or aqueous based solution.

A cleaning chamber 30 or receptacle containing parts (the parts are not shown for clarity, but understood by one of ordinary skill in the art) for cleaning may be operatively associated with the reservoir 20 (e.g., sink 32 surmounted on the drum). In one embodiment, the cleaning chamber 30 may be configured as a sink 32 including a basin 34, a drain 36, a collar 38, a lid 33 connected to the sink 32 by hinges 37 and a light 35. In another embodiment, the cleaning camber 30 may be configured as a spray area or volume, such as a spray cleaning cabinet. It is within the teachings of the present disclosure that the cleaning chamber 30 may be not only mounted on or connected to the reservoir 20 but also may be disposed adjacent to or remote from the reservoir 20 as desired to facilitate the intended structural arrangement yet still provide the applicable functionality. Additionally, it is within the teachings of the present disclosure that a fusible link (not shown for clarity) may be provided in connection with the lid 33 to enhance the safety of operation of the part washer assembly 100, as is known in the art.

A dispenser assembly 40 may be disposed in the cleaning chamber 30 for dispensing the cleaning solution 24 in the cleaning chamber 30. In one embodiment, the dispenser assembly may include a spigot 42 and a brush 44. It is within the teachings of the present disclosure that the dispenser assembly 40 may include any suitable device for dispensing the cleaning solution 24 on to the parts in the cleaning chamber 30. Preferably, the dispenser assembly 40 is connected to a discharge from the pump 62. In one embodiment, a coiled hose 61 connected to the pump 62 communicates with the discharge port on the pump 62 and the dispenser assembly 40 to facilitate a conduit for the cleaning solution 24 to be circulated from the reservoir to the dispenser assembly 40 in the cleaning chamber 30. One of skill in the art will recognize that the coiled hose 61 may have any suitable configuration and be made of any suitable material.

A control assembly 50 may be operatively connected to one of the reservoir 20 and the cleaning chamber 30. In one embodiment, the control assembly 50 facilitates operation of the parts washer assembly 100 in that the control assembly 50 is connected to a power supply 52 by a power cord 51, to the pump 62 by a control line 54 that extends from the control assembly 50 to the pump 62 through a protective conduit 53 and to a switch 74. The power supply 52 provides electrical power to the control assembly 50 that may distribute the electrical power to activate the pump 62 when the applicable circuit in the control assembly 50 is made or closed (e.g., a switch or relay is actuated as is known in the art); provided that the switch 74 is disposed in a normally closed or made and not open position. Other and additional functionality may be provided by the control assembly 50 as one of ordinary skill in the art would expect. For example, control over the activation of the light 35, operational characteristics of the pump 62 (e.g., pulsing, continuous, etc.), control over the dispenser assembly 40 or control over a pneumatic or hydraulic source.

A circulator assembly 60 may be disposed in the reservoir 20 and operatively connected to the dispenser assembly 40 and the control assembly 50. The circulator assembly 60 may include a pump 62, a float 64 connected to the pump 62 to generate a neutral buoyancy such that the pump 62 is disposed above the bottom 22 and below the surface 26, a bracket 66 connected to one of the pump 62 and the float 64, and a track 72 slidably engaging the guide 68 so as to constrain movement of the pump 62, the track 72 including a switch 74 adjustably disposed in the track 72 to define a minimum pump orientation 76, wherein, when actuated by interaction with the actuator 70, the switch 74 deactivates the circulator assembly 60.

In one embodiment, the pump 62 may be an suitable submersible pump (e.g., electrical, pneumatic, hydraulic, etc.) having an inlet and a discharge port, either disposed at any suitable location on the pump 62. When activated, the pump 62 draws in the cleaning fluid 24 from the reservoir 20 through the inlet and discharges the cleaning fluid 24 from the discharge port (preferably into the coiled hose 61 in order to communicate with the dispenser assembly 40 as described herein).

In one embodiment, the float 64 may have any suitable configuration provided that it is configured to generate a neutral buoyancy where the pump 62 inlet is disposed at a desired position above the bottom 22 and below the surface 26. Preferably, the neutral buoyancy position is reference with respect to a certain desired distance below the surface 26 so as to avoid the disadvantages of the prior art. One of ordinary skill in the art will recognize that neutral buoyancy is a condition in which a physical body's mass equals the mass it displaces in a surrounding medium. This offsets the force of gravity that would otherwise cause the object to sink. Accordingly, an object that has neutral buoyancy will neither sink nor rise, but rather will maintain its desired position. The position above the bottom 22 may be controlled by the switch 74 and control assembly 50 as described herein. For example, the float 64 may be configured to surround the pump 62.

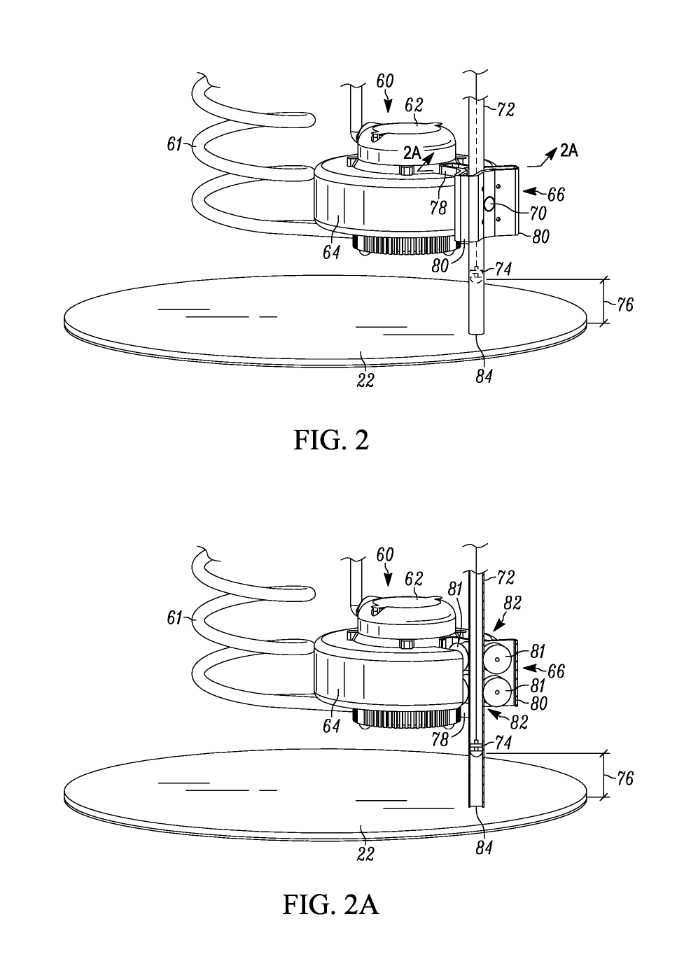

The bracket 66, in one embodiment, may include an arm 78 to space the pump 62 from a wall 21 of the reservoir 20, a guide 68 (see FIG. 2A) to constrain movement of the pump 62 and an actuator 70 (see FIG. 2 for greater clarity). The arm 78 may facilitate connection of the bracket 66 to one of the pump 62 and float 64. For example, in one embodiment, the bracket may include the arm 78 and two extensions 80 in a generally equally-spaced, tri-lobe configuration, wherein the arm 78 extends into and is connected to the float 64 and the two extensions 80 project away from a proximate portion of the arm 78 at separate angles to provide a stable contact with the wall 21 of the reservoir 20 to facilitate consistent spacing of the circulator assembly 60 throughout the range of movement. In one embodiment, the guide 68 may have any suitable configuration that is complementary to the track 72 in order to provide the intended functionality. For example, the guide 68 may be configured as a passage 82 formed in or on the bracket 66 having a complementary shape to the track 72, such as, a T-slot, a U-shape, cylinder, etc., or defined by a plurality of elements 81 disposed in or on the bracket 66 complementary to the track 72, such as, rollers, projections, etc., or any other suitable configuration to provide the intended functionality. The actuator 70 may be configured as a magnet or any other suitable apparatus to cooperate with the switch 74 to open the switch 74 in order to deactivate the pump 62. For example, the actuator 70 may be a projection to engage a micro-switch or other suitable apparatus to provide the intended functionality.

In one embodiment, the track 72 may include a distal end 84 disposed adjacent the bottom 22 and a proximate end 86 disposed above the surface 26 and have any suitable configuration, such as, for example, a tubular structure defining a bore 84, so that the switch 74 may disposed within the bore 84, protected from the cleaning solution 24. It is within the teachings of the present disclosure that the switch 74 may be disposed at a desired height, position or orientation 76 that is relative to a configuration of the reservoir 20. For example, in a reservoir 20 having a large bottom 22 area, the build-up of contaminants may take a long time, accordingly, the orientation may be disposed more close to the bottom 22 than in reservoir 20 with a small bottom 22 area, which will experience a faster build-up of contaminants.

FIG. 2 is a partial detailed view of a circulator assembly of FIG. 1, where the wall of the reservoir is removed for greater clarity. In this embodiment, the coiled hose 61 is connected to the discharge port that is disposed on a lower portion of the pump 62 opposite but adjacent the inlet. In FIG. 2 the float 64 is more clearly illustrated as surrounding an external perimeter of the pump 62. In this embodiment, such configuration enables a convenient manner of connection between the float 64 and the arm 78 of the bracket 66, such that the arm 78 may extend from an area of the bracket 66 that surrounds the guide 68 in the direction of the pump 62 so as to fully engage the float 64 across nearly the vertical extent of the arm 78. It is within the teachings of the present disclosure that other suitable connections may be made with the bracket 66, including the arm 78 and the pump 62. The actuator 70 is more clearly shown in FIG. 2. In one embodiment, the actuator 70 is preferably disposed adjacent the track 72 for satisfactory actuation or activation of the switch 74. In one embodiment, the switch 74 may be configured as a reed switch that is normally closed and opens when a magnetic field is applied (by the actuator 70 when configured as a magnet). The two extensions 80 and the arm 78, in one embodiment, are equally spaced from one another. Preferably, the two extensions 80 extend from the area of the bracket 66 that surrounds the guide 68 with at least a component of direction opposite from the arm 78 in order to provide spacing for the circulator assembly 60 from the wall of the reservoir, in order to avoid potential intake of contaminant build-up on the wall of the reservoir by the pump 62. The orientation or position 76 of the switch 74 is shown in an extraordinarily low location for the sake of clarity, but would usually be disposed higher when in actual use for the advantages described above. Additionally, the orientation or position 76 is adjustable to accommodate different reservoirs or contaminate build-up. Preferably, the distal end 84 of the track 72 engages or contacts the bottom 22 for a more positive disposition of the track 72, but obviously, such arrangement is not required.

FIG. 2A is a partial cross-sectional view of the circulator assembly 60 of FIG. 2. The guide 68 is disposed in the central portion of the bracket 66 in this embodiment. However, such location disposition is not a requirement, but rather an expedient solution for the intended functionality. One of ordinary skill in the art will recognize that numerous other alternatives exist for configuring and orienting the guide 68 on the bracket 66. In one embodiment, the guide 66 may be configured as a cylindrical passage or having any other shape complementary to the track 72.

FIG. 3 is a top perspective partially cut-away view of one embodiment of the parts washer assembly 100 of FIG. 1. In this embodiment, the parts washer assembly 100 operates in accordance with the teachings of this disclosure where the surface 26 is disposed at one level 102. The circulator assembly 60 has a neutral buoyancy and is disposed below the surface 26 and above the bottom 22 for the advantages described in this disclosure. The circulator assembly 60 will continue to be activated by the control assembly 50 because the switch 74 is disposed at an orientation 76 below the circulator assembly 60 and the actuator 70 disposed thereon.

FIG. 4 is top perspective partially cut-away view of one embodiment of the parts washer assembly 100 of FIG. 1. In this embodiment, the parts washer assembly 100 also operates in accordance with the teachings of this disclosure where the surface 26 is disposed at another level 104. The circulator assembly 60 has a neutral buoyancy and is disposed below the surface 26 and above the bottom 22 for the advantages described in this disclosure. The circulator assembly 60 will be deactivated by the control assembly 50 because the actuator 70 of the circulator assembly 60 is disposed at the orientation of the switch 74, whereupon the circuit for the switch 74 is opened.

The preceding detailed description is merely some examples and embodiments of the present disclosure and that numerous changes to the disclosed embodiments can be made in accordance with the disclosure herein without departing from its spirit or scope. The preceding description, therefore, is not meant to limit the scope of the disclosure but to provide sufficient disclosure to one of ordinary skill in the art to practice the invention without undue burden.

What is claimed is:

1. A parts washer comprising: a reservoir including a bottom; a cleaning solution disposed within the reservoir including a surface; a cleaning chamber operatively associated with the reservoir; a dispenser assembly disposed in the cleaning chamber for dispensing the cleaning solution in the cleaning chamber; a control assembly operatively connected to one of the reservoir and the cleaning chamber; and a circulator assembly disposed in the reservoir and operatively connected to the dispenser assembly comprising a pump; a float connected to the pump to generate a neutral buoyancy such that the pump is disposed above the bottom and below the surface; a bracket connected to one of the pump and the float, the bracket including a guide and an actuator; a track slidably engaging the guide so as to constrain movement of the pump, the track including a switch adjustably disposed in the track to define a minimum pump orientation, wherein, when actuated by interaction with the actuator, the switch deactivates the circulator assembly.

2. The parts washer as recited in claim 1, wherein the bracket further comprises an arm to space the pump from a wall of the reservoir.

3. The parts washer as recited in claim 2, wherein the arm includes two extensions.

4. The parts washer as recited in claim 1, wherein the guide is configured as a cylindrical passage.

5. The parts washer as recited in claim 1, wherein the track further comprises a bore.

6. The parts washer as recited in claim 5, wherein the switch is disposed within the bore.

7. The parts washer as recited in claim 1, wherein the switch is disposed at a desired orientation that is relative to a configuration of the reservoir.

8. The parts washer as recited in claim 1, wherein the track includes a distal end disposed adjacent the bottom and a proximate end disposed above the surface.

9. A circulator assembly for use in connection with a parts washer including a reservoir having a bottom, and a cleaning solution disposed in the reservoir having a surface, the circulator assembly comprising: a pump; a float connected to the pump to generate a neutral buoyancy such that the pump is disposed above the bottom and below the surface; a bracket connected to one of the pump and the float, the bracket including a guide and an actuator; a track slidably engaging the guide so as to constrain movement of the pump, the track including a switch adjustably disposed in the track to define a minimum pump position, wherein, when actuated by interaction with the actuator, the switch deactivates the circulator assembly.

10. The circulator assembly as recited in claim 9, wherein the bracket further comprises an arm to space the pump from a wall of the reservoir.

11. The circulator assembly as recited in claim 10, wherein the arm includes two extensions.

12. The circulator assembly as recited in claim 9, wherein the guide is configured as a passage.

13. The circulator assembly as recited in claim 9, wherein the track further comprises a bore.

14. The circulator assembly as recited in claim 13, wherein the switch is disposed within the bore.

15. The circulator assembly as recited in claim 9, wherein the track includes a distal end disposed adjacent the bottom and a proximate end disposed above the surface.

16. A circulator assembly for a body of cleaning solution having a surface, the circulator assembly comprising: a floating pump disposed below the surface, the pump slidably engaging a track to constrain movement of the pump, the track including a switch that, when actuated by interaction of the adjacent pump, deactivates the circulator assembly.

17. The circulator assembly as recited in claim 16, further comprising a bracket connected to the pump, the bracket including a guide to engage the track and an actuator that interacts with the switch.

18. The circulator assembly as recited in claim 17, wherein the bracket further comprises an arm to space the pump from a wall of the reservoir.

19. The circulator assembly as recited in claim 16, wherein the track further comprises a bore.

20. The circulator assembly as recited in claim 19, wherein the switch is disposed within the bore.
